(19) United States
(12) Patent Application Publication
(10) Pub. No.: US 2015/0124319 A1
(43) Pub. Date: May 7, 2015

(54) Dual Resonance Pumped Two-Photon Absorption Optical Filter

(71) Applicant: Joseph Daniel Vance, Scotts Valley, CA (US)

(72) Inventor: Joseph Daniel Vance, Scotts Valley, CA (US)

(21) Appl. No.: 14/531,965

(22) Filed: Nov. 3, 2014

Related U.S. Application Data
(62) Division of application No. 61/899,245, filed on Nov. 3, 2013.
(60) Provisional application No. 61/899,245, filed on Nov. 3, 2013.

(51) Int. Cl. G02F 1/09; G02F 1/35; G02B 27/28

(52) U.S. Cl. CPC G02F 1/091; G02B 27/288; G02F 1/3526
USPC 359/484.09; 359/489.01

(57) ABSTRACT

An apparatus is disclosed for filtering of probe light. The apparatus includes an optical filter comprised of a medium circular birefringence between crossed polarizers. The circular birefringent medium changes the polarization of light of a particular frequency bandwidth. So that after passing through the first polarizer, the polarization of a particular frequency bandwidth probe light is rotated between crossed polarizers so it will be transmitted through the second polarizer. The birefringent medium is constructed from a gaseous substance such as atomic vapor and two pump lasers in resonance with absorption lines of the absorbing substance by the process of two-photon absorption. A magnetic field is utilized in some embodiments that permeates the absorbing substance and separates absorption lines for excited state transitions by the Zeeman effect.

### FIELD OF THE INVENTION

This invention relates to optical filters utilizing circular birefringence induced by an absorption line to rotate the polarization of light. The polarization rotation is used between crossed polarizers such that a narrow bandwidth of light propagates through while light not interacting with the absorption line is blocked.

### BACKGROUND OF THE INVENTION

Optical faraday filters that employ absorption lines are in widespread use, however they only occur at particular wavelengths. Optical filters based upon two-photon absorption are known to the prior art but they have serious drawbacks. A new optical filter that uses dual absorption lines at the pump wavelength results in a filter with high transmission and eliminates optical pumping which interferes with filter operation.

### BRIEF DESCRIPTION OF THE SEVERAL VIEWS OF THE DRAWING

FIG. 1(a) shows a theoretical example the real (χ′) and imaginary (χ″) portions of the electric susceptibility near an absorption line.

FIG. 1(b) shows a schematic diagram of the major components of a dual resonance pumped two-photon absorption optical filter in accordance with one embodiment of the current invention.

FIG. 2(a) is a diagram of rubidium spectra.

FIG. 2(b) is a plot of hypothetical real and imaginary susceptibility for a dual resonance pumped two-photon absorption optical filter in accordance with one embodiment of the current invention.

FIG. 3(a) shows a theoretical transmission spectrum through a dual resonance pumped two-photon absorption optical filter.

FIG. 3(b) shows a schematic diagram of the major components of a magneto-optic dual resonance pumped two-photon absorption optical filter.

FIG. 4(a) is an example diagram of rubidium spectra in the presence of a longitudinal magnetic field.

FIG. 4(b) is a plot of hypothetical real and imaginary susceptibility for a magneto-optic dual resonance pumped two-photon absorption optical filter in accordance with one embodiment of the current invention.

### DETAILED DESCRIPTION OF THE INVENTION

Several drawings illustrate physical the attributes of optical filters along with quantities that may be manifested with its construction, in accordance with embodiments of the present invention. Examples are described that have particular absorbing substances, mediums, transitions, wavelengths of complimentary light pairs, etc. for purposes of illustration. However, it should be noted that the choices of particular absorbing substance and particular transitions are abundant. Also, while concomitant to the chosen transitions, the wavelengths of the probe light have wide latitude of choice upon a continuum. Thus it is recognized that the apparatus and means described herein may vary without departing from the basic underlying concepts of the invention.

An optical filter transmits a frequency pass band of light and rejects light outside the pass band. The current invention is an optical filter utilizing two-photon absorption lines to create a circularly birefringent medium to rotate light polarization. Accompanying absorption is dispersion, and dispersion is utilized to create the birefringent medium to rotate polarization orientation. The polarization rotation allows light to be transmitted through crossed polarizers.

Consider an atomic transition from a ground state (lowest allowed energy state of an atom) to an excited state. The atom will absorb a photon only if the energy of the photon matches the energy of the transition. An absorption line is a frequency bandwidth of light that can be absorbed by a substance and is associated with a transition of the absorbing substance from one state to another. For example, an absorbing substance for one embodiment of the present invention is atomic ⁸⁵Rb. Rubidium has an absorption line near a wavelength of 780.4 nm. The transition associated with this absorption line is a rubidium electron in the 5s state that changes orbit to the 5p state. When light is of the correct wavelength, having the same energy as the transition energy, there is resonance absorption. The ground and exited states may have different energies depending upon other interactions. The fine structure refers to the interaction between electron spin and electron orbit. The hyperfine structure refers to the interaction between the nucleus and the electron. In the ground state s with zero orbital angular momentum, there is significantly more interaction with the nucleus than the p state or other states that have orbital angular momentum. Here, the hyperfine separation of energy of excited states having non-zero angular momentum is considered insignificant. But the hyperfine difference in energy states of the ground state and excited states having zero angular momentum of some elements in atomic form is significant. Rubidium 85 has a difference in energy corresponding to a difference in frequency of 3.136 GHz. Therefore rubidium will have two absorption lines, and ignoring the hyperfine structure of the excited state p state, the difference in frequency between the two absorption lines will be approximately 3.136 GHz. Here, to create an optical filter, two absorption lines are utilized to work together to make an optical filter. In the prior art, one pump laser source is used to create a filter, but the filter has serious drawbacks.

Preferential absorption or resonance absorption also affects light phase, or dispersion. The electric susceptibility is used to describe both the absorption and dispersion effects. The real portion of the electric susceptibility affects light phase while the imaginary portion of the susceptibility quantifies absorption. Whenever the real portion electric susceptibility is different for each circular polarization states of linear polarized light, then the medium becomes circularly birefringent. Linear polarized light will undergo polarization rotation to another linear polarized state while traveling through a circular birefringent medium. To quantify the birefringence, the electric susceptibility can be used and is defined here in terms of dielectric polarization density:

\vec{P}=∈ₒχ\vec{E} Equation 1

Where the electric susceptibility χ is the proportionality constant linking the electric field of the probe light to the dielectric polarization, and ∈ₒ is the permittivity of free space. The electric susceptibility χ is dimensionless and also a complex quantity, and is expressed in component form as:

χ=χ′−χ″ Equation 2

Using a circular polarization basis to express linear light, with some minor approximations and removing time dependence, the electric field of light after traveling a distance/within a circularly birefringent medium is:

$$\vec{E} ( l ) = - \frac{{E}_{o}}{\sqrt{2}} exp [ i \{ \frac{ω}{c} ( 1 + \frac{{χ}_{+}^{′}}{2} + i \frac{{χ}_{+}^{″}}{2} ) l \} ] \hat{+} + \frac{{E}_{o}}{\sqrt{2}} exp [ i \{ \frac{ω}{c} ( 1 + \frac{{χ}_{-}^{′}}{2} + i \frac{{χ}_{-}^{″}}{2} ) l \} ] \hat{-} \qquad Equation 3$$

Where ω is the angular frequency and c is the speed of light. Equation 3 demonstrates that χ′, the real portion of the electric susceptibility, affects phase, while χ″, the imaginary portion of the electric susceptibility, is related to absorption. The subscripts, plus and minus, attached to the susceptibilities identifies to which circular polarization state the electric susceptibility applies to: right and left handed polarization, respectively. Notice that the field vector is written in a circular polarization basis.

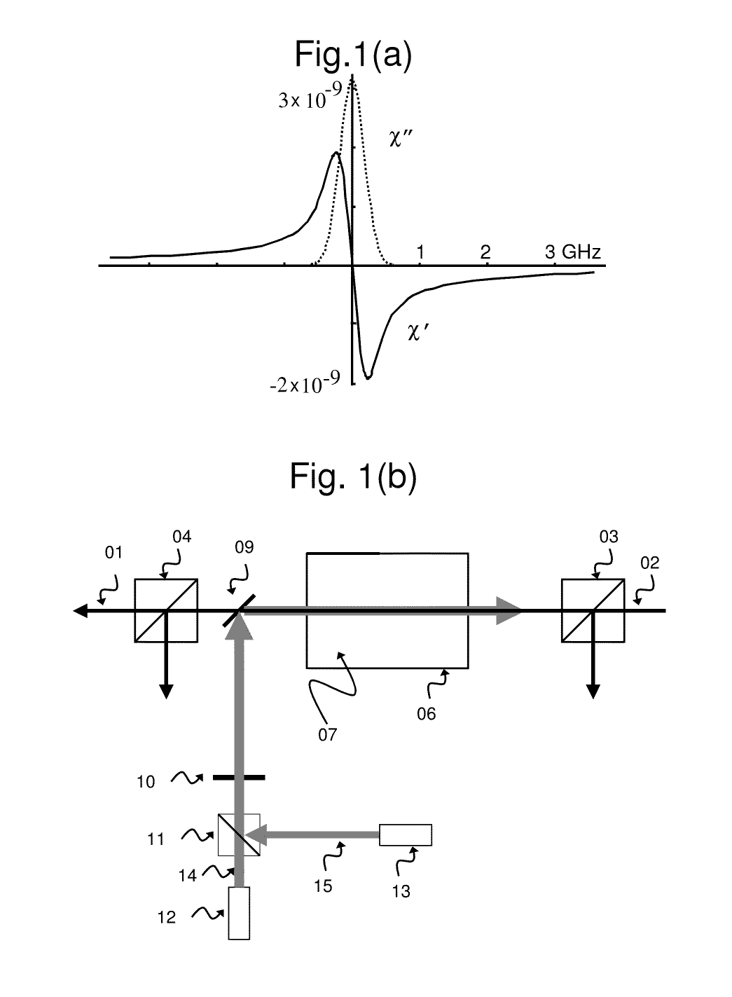

The susceptibility is an analytic function. This has implications to the relationship of the real and imaginary portions of the susceptibility. The real and imaginary portions of the susceptibility are inexorably linked. In fact, if one is known then the other can be derived from it. Thus absorption can't be suppressed without also suppressing dispersion. FIG. 1(a) is an example of the real and imaginary susceptibility from an absorption line. The region where the real portion of susceptibility changes most rapidly with frequency is also the region where absorption occurs.

### Two-Photon Absorption

Two-photon absorption is utilized to create a circularly birefringent medium. Consider an atomic transition from a ground state (lowest allowed energy state of an atom) to an intermediate excited state, which can occur with the absorption of a single photon. Furthermore, consider another transition from the intermediate excited state to another still higher energy state, a final excited state that can occur with the absorption of a single photon. Two-photon-absorption is the direct transition from the ground state to the final excited state, avoiding the intermediate state, by the simultaneous absorption of two photons. A two-photon-transition identifies the states of the substance involved in two-photon-absorption. A two-photon-absorption line is a frequency bandwidth of light that can be absorbed by the process of two-photon-absorption, and is associated with a two-photon transition. Here, pump light is utilized to make a circularly birefringent medium for the probe light. The pump light may have a frequency near that required for a transition from the ground state to the intermediate excited state. The probe light may have a frequency near that required for a transition from the intermediate excited state and the final excited state.

In the case of two-photon-absorption, the only restriction upon the energy of the photons is that the sum of their energies match the total energy of the atomic transition:

$${E}_{excited} - {E}_{ground} = \frac{hc}{{λ}_{1}} + \frac{hc}{{λ}_{2}} \qquad Equation 4$$

Equation (4) demonstrates that there is some freedom of choice of wavelengths λ₁ & λ₂. Conservation of energy requires only that the sum of the two photon energies match the two photon transition, which is a considerably relaxed condition compared to a sequential transition, where each photon energy individually matches the transition energy. Resonance of wavelength λ₁ with an absorption line is not required nor excluded in the two-photon-absorption process. But, the two-photon cross section is reduced rapidly as the photons move away from single photon resonance, thus it is advantageous to have the frequency (energy)) of the photons coincide as much as possible to the energy of the single photon transitions. In the current invention, there is two pump lasers both of which are in resonance with a different absorption line.

Practical two-photon-absorption involves the rigid application of angular momentum selection rules. Because conservation of angular momentum is never violated, selection rules place restrictions upon the interaction of light with matter, and are exploited to produce circular birefringence. In units of , all photons have an angular momentum. Since angular momentum is a vector, it has magnitude and direction. A photon with right-handed circular polarization has an angular momentum direction opposite to the propagation direction, and a magnitude of one. A photon with left-handed circular polarization has an angular momentum direction in the same direction as the propagation direction, and a magnitude of one. Circularly polarized light is in a stationary or Eigen state. Linearly polarized light on the other hand has angular momentum of one, but the direction is in a super position of Eigen states. Upon absorption of a photon the angular momentum vector is transferred into the system that absorbs it. But in the case of linearly polarized light, the direction of the transferred angular momentum vector is equally likely to be in the forward direction as the backwards direction.

For atomic dipole transitions, or allowed transitions, there is a change in magnitude of angular momentum between the initial state and final state of one, with the emission or absorption of a single photon. Consider a sequence of two dipole transitions of an atom. Beginning with lowest energy state of the atom, the ground state, a transition can occur to an excited state, denoted here as an intermediate excited state, with absorption of a photon. Then another transition can occur from the intermediate excited state to a final excited state with another photon absorption. By vector addition, angular momentum that the ground state and the final excited state have may differ by zero or two (e.g., 1−1=0; 1+1=2). Now consider the same situation except that instead of sequential absorption of two photons there is simultaneous absorption of two photons, denoted two-photon-absorption. If the angular momentum of the atom's ground state and final excited state are identical, then two-photon-absorption can occur only with a photon pair that have angular momentum vectors aligned in opposite directions. Similarly, if the angular momentum of the atom's ground state and the final excited state differ by two, then two-photon-absorption can occur only with a photon pair that have angular momentum that is aligned in the same direction. Extrapolating from single photons to beams, all the photons of a circularly polarized beam of light have their angular momentum vectors aligned in the same direction. When a pump light beams is circularly polarized, then two-photon absorption can occur for only one circular component of the probe light. A birefringent medium for the probe light is then manifested.

A magnetic field may also be used to create a birefringent medium in an absorbing substance. For some embodiments of the current invention, two-photon absorption is utilized to create birefringence without a magnetic field present. In other embodiments of the current invention, both two-photon absorption and a longitudinal magnetic field is utilized to create a birefringent medium. A magnetic field is a longitudinal magnetic field when its direction is predominately the same or opposite relative to the propagation direction of some particular light source. A magnetic field may split the transition energy of some substances, known as Zeeman splitting. A longitudinal magnetic field that permeates some substances will shift up or down the energy level of the energy states of the substance. This will cause a shift in the frequency of resonance for one circular component of light, and shift down in the frequency of resonance for the other (opposite) circular component of light.

The examples that follow use rubidium vapor as an absorbing substance that is subjected to a longitudinal magnetic field. The absorbing substance is not restricted to atomic vapors. The Zeeman effect also applies other substances as well such as oxygen molecules O₂ which is paramagnetic. The Zeeman effect from the magnetic field upon the absorption lines depends upon the is substance and upon energy state the substance is in. For example the splitting frequency in Ghz of the p states of rubidium from a magnetic field in Tesla are quantifiable (approximate) by the following relationship: Δν(Ghz)=93×B(Tesla)

### Dual Resonance Pumped Two-Photon Absorption Optical Filter

Applying the above concepts we can begin to explain one embodiment of the current invention. The major components of a dual resonance two-photon absorption dispersion optical filter is illustrated in FIG. 1(b). The dual resonance pumped two-photon absorption optical filter passes through a frequency bandwidth of light, and rejects other frequency bandwidths of light. There may be two pump lasers, a first pump laser 12 emanating a first pump light 14, and a second pump laser 13 emanating a second pump light 15. The first pump laser 12 may be a distributed feedback laser operating near 794 nm. The second pump laser 13 may be a distributed feedback laser operating near 794 nm. The first pump light 14 may be linear polarized and the second pump light may be linearly polarized, where the polarization of the first pump light 14 may be orthogonal relative to the second pump light 15. The first pump light 14 and the second pump light 15 may be combined into a single beam with a polarizing beam splitter 11. Next, the first pump light 14 and the second pump light 15 may propagate through a quarter wave plate 10. The quarter wave plate 10 transforms the polarization of the first pump light 14 into a first circular polarization state and transforms the second pump light 15 into a second circular polarization state where the first circular polarization state is opposite the second circular polarization state. A dichroic mirror 10 may be used to split the first pump light 14 and the second pump light 15 from the probe light 02. The probe light may be of a wavelength near 532 nm, which is close to resonance with a transition from the 5p state to the 10s transition in rubidium. The first pump light 14 and the second pump light 15 may then be directed into cell 6 that may contain an absorbing substance 07. An example of absorbing substance 07 is rubidium (⁸⁵Rb) vapor. Another example of absorbing substance is molecular oxygen O₂. A temperature controller may be used to maintain the temperature of the absorbing substance 07. The absorbing substance 07, the first pump light 14 and the second pump light combine to create a birefringent medium for the probe light 02. The probe light 02 may initially contain background light that may removed by the filter. The optical filter may contain two polarizers, of which they may be in orthogonal polarization orientation, a first polarizer 03 and a second polarizer 04. Note that orientation of the transmission axis of the second polarizer 04 relative to the transmission axis the first polarizer 03 is an angle along a continuum of possible angle orientations. Since orthogonal orientation angle is a single point, and a single point is without width, a tolerance is introduced. The definition of orthogonal orientation is expanded to include all orientations that are approximately orthogonal in orientation. The probe light 02 may pass through the first polarizer 03 and then be in a state of linear polarization. The probe light may continue through the cell 06 that may contain absorbing substance 07. Within cell 06 the probe light 02 may overlap with the first pump light 14. Within cell 06 the probe light 02 may overlap with the second pump light 15.

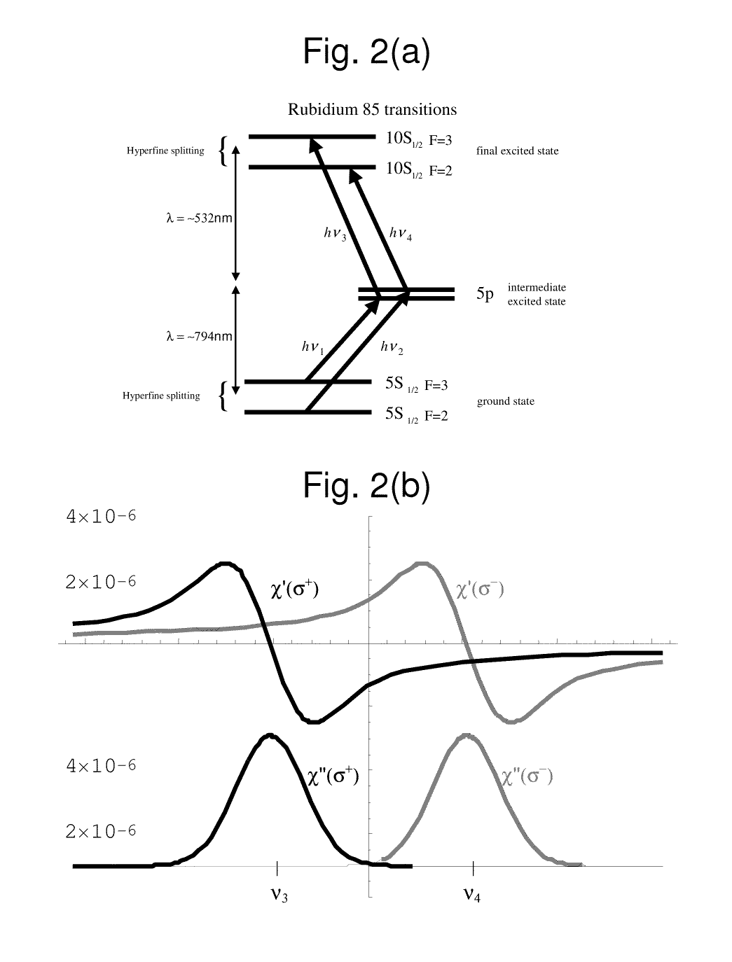

The spectra associated with the above described example of an embodiment of the invention is shown in FIG. 2(a). Referring to FIG. 2(a), The first pump light 14 may have a frequency of ν₁ and be in resonance with the transition from the ground state to the intermediate excited state. The second pump light 15 may have a frequency of ν₂ and be in resonance with the transition from the ground state to the intermediate excited state. With the first pump light 14 in single photon resonance with a transition and the second pump light 15 in resonance with a different transition, the two photon cross section is maximized. An absorption line for the transition from the intermediate excited state to the final excited state is manifested by the process of two-photon absorption, and the two-photon absorption selection rules may be applied. Since the first pump light 14 is circularly polarized, absorption from the intermediate excited state to the final excited state is allowed only for photons that have angular momentum opposite to that of the of first pump light 14. likewise, since the second pump light 15 is circularly polarized, absorption from the intermediate excited state to the final excited state is allowed only for photons that have angular momentum opposite to that of the of second pump light 15. Since the final excited state is an S state, it has hyperfine splitting similar to that of the ground state. Thus two absorption lines are created, one for left circularly polarized light, and another for right circularly polarized light which are separated in frequency.

Linear polarized light can be expressed in components of right circularly polarized light and left circularly polarized light denoted σ⁺ and σ⁻ respectively. After traveling through the first polarizer 03, the probe light 02 is in a linearly polarized state. Thus one circular component of the probe light 02 will have an absorption line at ν₃ and the other circular component of the probe light 02 will have an absorption line at ν₄. The theoretical susceptibility for the probe light 02 is plotted in FIG. 2(b).

After propagating through the cell 06, the probe light 02 that is within the pass band of the filter, which may be near wavelength 532 nm, will have its polarization rotated.

After propagating through the cell 06, the probe light 02 may propagate through a polarizer 03 that is oriented to pass light that is orthogonal to the polarization that the probe light 02 has before entering cell 06. The optical filter then passes a specific frequency pass band of probe light 02 and rejects other frequencies of light. The transmission through the optical filter can be calculated directly using equation 5. Choosing a coordinate system such that the first linear polarizer is oriented to pass light polarized in the x direction and that the second linear polarizer is oriented to pass light polarized in the y direction, the transmission of the pass band beam will be:

$$T = \frac{{\vert \vec{E} \cdot \hat{y} \vert}^{2}}{{E}_{o}^{2}} \\ T = \frac{1}{4} [ \begin{matrix}exp ( - \frac{ω}{c} {χ}_{+}^{″} l ) + exp ( - \frac{ω}{c} {χ}_{-}^{″} l ) - \\ 2 exp ( - \frac{ω}{c} \frac{{χ}_{+}^{″} + {χ}_{-}^{″}}{2} l ) cos ( \frac{ω}{c} \frac{{χ}_{+}^{′} - {χ}_{-}^{′}}{2} l )\end{matrix} ] \qquad Equation 5$$

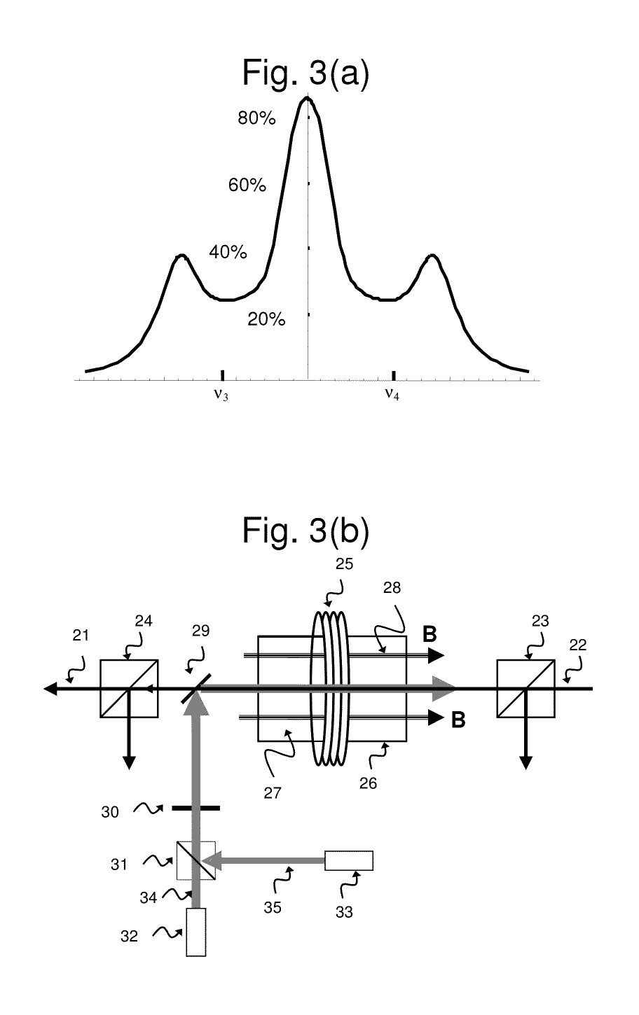

A theoretical plot of the transmission through the dual resonance optical filter using the equations listed above is shown in FIG. 3(a).

### Magneto-Optic Dual Resonance Pumped Two-Photon Absorption Optical Filter

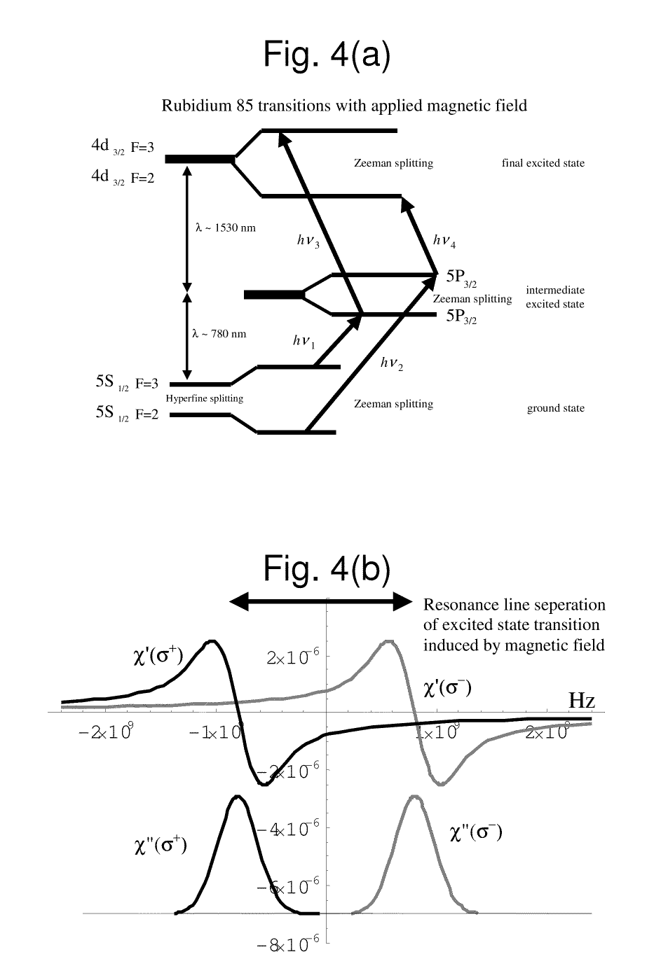

The optical filter embodiment described above has limitations. Since each pump laser is in resonance with a transition of the absorbing substance, and the probe light has resonance absorption as well, the spectral width of the filter is dictated by the absorbing substance. Rubidium has resonance lines that are particularly well spaced for some applications. Potassium, on the other hand has a much smaller hyperfine structure, small enough that is not resolvable at temperatures utilized in the current invention. Another problem arises when the final excited state and the intermediate excited state have very narrow structure such is the case when the transition within rubidium 85 is from the 5p to the 4d state. For some transitions and substances, when there is no magnetic field present, the absorption lines associtated with excited state transitions will not be siginficantly seperated. With the addition of a magnetic field, the absorption line separation is induced to a desired width, leading to a desired spectral width. The major components of a magneto-optic dual resonance optical filter is illustrated in FIG. 3(b). There may be two pump lasers, a first pump laser 32 emanating a first pump light 34, and a second pump laser 33 emanating a second pump light 35. An example of a first pump laser 32 is a distributed feedback laser operating near 780.34 nm. An example of a second pump laser 33 is a distributed feedback laser operating near 780.24 nm. The first pump light 34 may be linear polarized orthogonal relative to the second pump light 35. The first pump light 34 and the second pump light 35 may be combined into a single beam with a polarizing beam splitter 31. Examples of a polarizing beam splitters 31 include Wollaston prisms and Glan Thompson prisms. Next, the first pump light 34 and the second pump light 35 may propagate through a quarter wave plate 30. The quarter wave plate 30 transforms the polarization of the first pump light 34 into a first circular polarization state and transforms the second pump light 35 into a second circular polarization state where the first circular polarization state is opposite the second circular polarization state. A dichroic mirror 30 may be used to combine the first pump light 34 and the second pump light 35 with the probe light 22. The first pump light 34 and the second pump light 35 may then be directed into cell 26 that may contain an absorbing substance 27. An example of absorbing substance 27 is rubidium 85 vapor. The transitions involved in this example is the 5s->5p->4d as shown in FIG. 4(a). Another example of absorbing substance is molecular oxygen O₂. A temperature controller may be used to maintain the temperature of the absorbing substance 27. A longitudinal magnetic field 28, relative to the probe light 22, produced by magnet 25 may permeate the absorbing substance. The longitudinal magnetic field 28 splits the absorption lines of the absorbing substance 27 by the Zeeman effect. The Zeeman effect upon the absorption lines for rubidium 85 with a longitudinally applied magnetic field is also shown in FIG. 4(a). In the figure it also demonstrates that without Zeeman splitting, the transition frequency between the excited is approximately the same for left and right circularly polarized light.

The susceptibility for the probe light 22 is shown in FIG. 4(b). The transmission spectrum may be much like that shown in FIG. 3(a). The light that will be transmitted will have a wavelength near the excited state transition wavelength of 1530 nm.

What is claimed is:

1. An optical filter acting upon probe light, comprising:
(a) an absorbing substance with one or more absorption lines;
(b) a first pump light source having a first pump frequency and a first pump circular polarization;
(c) a second pump light source having a second pump frequency and a second pump circular polarization;
(d) a first polarizer;
(e) a second polarizer;
wherein the first pump circular polarization is different than the second pump circular polarization;
wherein the first pump frequency is in resonance with a first resonance line of the absorbing substance;
wherein the second pump frequency is in resonance with a second resonance line of the absorbing substance;
wherein the first resonance line is of different frequency than the second resonance line;
wherein the absorbing substance and the first light source and the second light source combine to form a birefringent medium for the probe light by the process of two-photon absorption;
wherein the second polarizer transmission axis is oriented approximately orthogonal relative to the first polarizer transmission axis;
wherein the probe light is directed into the first polarizer and some of the probe light is transmitted through the first polarizer and,
then the probe light propagates through the birefringent medium and, then is directed into the second polarizer;
wherein the polarization of some of the probe light having a frequency within a transmission bandwidth is rotated by the birefringent medium and transmitted through the second polarizer.

2. An optical filter acting upon probe light, comprising:
(a) an absorbing substance with one or more absorption lines;
(b) a first pump light source having a first pump frequency and a first pump circular polarization;
(c) a second pump light source having a second pump frequency and a second pump circular polarization;
(d) a first polarizer;
(e) a second polarizer;
(f) a longitudinal magnetic field;
wherein the first pump circular polarization is different than the second pump circular polarization;
wherein the first pump frequency is in resonance with a first resonance line of the absorbing substance;
wherein the second pump frequency is in resonance with a second resonance line of the absorbing substance;
wherein the first resonance line is of different frequency than the second resonance line;
wherein the absorbing substance and the first light source and the second light source and the magnetic field combine to form a birefringent medium for the probe light by the process of two-photon absorption;
wherein the second polarizer transmission axis is oriented approximately orthogonal relative to the first polarizer transmission axis;
wherein the probe light is directed into the first polarizer and some of the probe light is transmitted through the first polarizer and,
then the probe light propagates through the birefringent medium and,
then is directed into the second polarizer;
wherein the polarization of some of the probe light having a frequency within a transmission bandwidth is rotated by the birefringent medium and transmitted through the second polarizer.
